(19) United States
(12) Patent Application Publication
(10) Pub. No.: US 2025/0274912 A1
(43) Pub. Date: Aug. 28, 2025

(54) METHOD AND APPARATUS RELATED TO REFERENCE SIGNAL SYMBOLS FOR UPLINK TRANSMISSIONS

(71) Applicant: Nokia Technologies Oy, Espoo (FI)

(72) Inventors: Jingyuan SUN, Beijing (CN); Alessio MARCONE, Munich (DE); Frank FREDERIKSEN, Klarup (DK); Mads LAURIDSEN, Gistrup (DK); Amir Mehdi AHMADIAN TEHRANI, Munich (DE)

(21) Appl. No.: 18/859,428

(22) PCT Filed: Apr. 29, 2022
(86) PCT No.: PCT/CN2022/090793

§ 371 Date: Oct. 23, 2024

(51) Int. Cl. H04W 72/0446; H04L 5/00; H04L 27/26; H04W 72/21

(52) U.S. Cl. CPC H04W 72/0446; H04L 5/0048; H04L 27/2613; H04W 72/21

(57) ABSTRACT

The present disclosure relates to method and apparatus related to reference signal symbols for uplink transmissions.

### TECHNICAL FIELD

The present disclosure relates to apparatus, a method, and a computer program, and in particular, but not exclusively to apparatus, methods and computer programs related to reference signal symbols for uplink transmissions.

### BACKGROUND

The timing of making uplink transmissions from a user equipment to an access network may depend on the propagation delay of transmissions between the user equipment and the access network. An uplink transmission may include reference symbols to assist the demodulation of other symbols of the uplink transmission.

### SUMMARY

A method, comprising: adopting, for an uplink transmission from a user equipment, a modified pattern of one or more time positions for reference signal symbols, such that the reference signal symbols for the uplink transmission do not occur in a region of overlap between a time unit for the uplink transmission and a time unit for another uplink transmission from the user equipment.

The reference signal symbols may facilitate demodulation of symbols of the uplink transmission.

The modified pattern of time positions may be different to another pattern of time positions used for the another uplink transmission.

The uplink transmission may be after the another uplink transmission.

The uplink transmission may comprise repetitions of data in respective groups of one or more uplink transmission slots, and the method may comprise adopting the modified pattern of time positions selectively for the group of uplink transmission slots at the start of the uplink transmission.

The modified pattern of time positions may be different to the another pattern of time positions at least in relation to the time position of the earliest reference signal symbol for the uplink transmission.

The modified pattern of time positions may be different to the another pattern of time positions at least in relation to the earliest symbol of the uplink transmission.

The uplink transmission may be before the another uplink transmission.

The uplink transmission may comprise repetitions of data in respective groups of one or more uplink transmission slots, and the method may comprise adopting the modified pattern of time positions for a plurality of the groups of uplink transmission slots.

The uplink transmission may comprise repetitions of data in respective groups of one or more uplink transmission slots, and the method may comprise adopting the modified pattern of time positions selectively for the group of uplink transmission slots at the end of the uplink transmission.

The modified pattern of time positions may be different to the another pattern of time positions at least in relation to the time position of the last reference signal symbol for the uplink transmission.

The modified pattern of time positions may be different to the another pattern of time positions at least in relation to the last symbol of the uplink transmission.

The modified pattern of time positions may take into account a change in timing advance between the uplink transmission and the another uplink transmission.

Adopting the modified pattern of time positions may be dependent on the change in timing advance exceeding a threshold value.

The modified pattern may be a pre-defined pattern.

The modified pattern may be a pattern configured in downlink control information, medium access control or radio resource control signaling.

The modified pattern of time positions may be based at least partly on a size of the change in timing advance.

The modified pattern of time positions may be based at least party on symbol length.

A method, comprising: demodulating an uplink transmission from a user equipment, wherein the demodulating is performed on the basis that the uplink transmission adopts for reference signal symbols a pattern of time positions such that the reference signal symbols for the uplink transmission do not occur in a region of overlap between a time unit for the uplink transmission and a time unit for another uplink transmission from the user equipment.

A method, comprising: transmitting from a network entity serving a user equipment, information about modifying an uplink pattern of time positions for reference signal symbols, such that the reference signal symbols for an uplink transmission from the user equipment do not occur in a region of overlap between a time unit for the uplink transmission and a time unit for another uplink transmission from the user equipment.

User equipment comprising: means for adopting, for an uplink transmission from the user equipment, a modified pattern of one or more time positions for reference signal symbols, such that the reference signal symbols for the uplink transmission do not occur in a region of overlap between a time unit for the uplink transmission and a time unit for another uplink transmission from the user equipment.

The reference signal symbols may facilitate demodulation of symbols of the uplink transmission.

The modified pattern of time positions may be different to another pattern of time positions used for the another uplink transmission.

The uplink transmission may be after the another uplink transmission.

The uplink transmission may comprise repetitions of data in respective groups of one or more uplink transmission slots; and the user equipment may comprise means for adopting the modified pattern of time positions selectively for the group of uplink transmission slots at the start of the uplink transmission.

The modified pattern of time positions may be different to the another pattern of time positions at least in relation to the time position of the earliest reference signal symbol for the uplink transmission.

The modified pattern of time positions may be different to the another pattern of time positions at least in relation to the earliest symbol of the uplink transmission.

The uplink transmission may be before the another uplink transmission.

The uplink transmission may comprise repetitions of data in respective groups of one or more uplink transmission slots, and the user equipment may comprise means for adopting the modified pattern of time positions for a plurality of the groups of uplink transmission slots.

The uplink transmission may comprise repetitions of data in respective groups of one or more uplink transmission slots, and the user equipment may comprises means for adopting the modified pattern of time positions selectively for the group of uplink transmission slots at the end of the uplink transmission.

The modified pattern of time positions may be different to the another pattern of time positions at least in relation to the time position of the last reference signal symbol for the uplink transmission.

The modified pattern of time positions may be different to the another pattern of time positions at least in relation to the last symbol of the uplink transmission.

The modified pattern of time positions may take into account a change in timing advance between the uplink transmission and the another uplink transmission.

Adopting the modified pattern of time positions may be dependent on the change in timing advance exceeding a threshold value.

The modified pattern may be a pre-defined pattern.

The modified pattern may be a pattern configured in downlink control information, medium access control or radio resource control signaling.

The modified pattern of time positions may be based at least partly on a size of the change in timing advance.

The modified pattern of time positions may be based at least party on symbol length.

Apparatus, comprising: means for demodulating an uplink transmission from a user equipment, wherein the demodulating is performed on the basis that the uplink transmission adopts for reference signal symbols a pattern of time positions such that the reference signal symbols for the uplink transmission do not occur in a region of overlap between a time unit for the uplink transmission and a time unit for another uplink transmission from the user equipment.

Apparatus, comprising: means for transmitting information about modifying an uplink pattern of time positions for reference signal symbols, such that the reference signal symbols for an uplink transmission from a user equipment do not occur in a region of overlap between a time unit for the uplink transmission and a time unit for another uplink transmission from the user equipment.

User equipment comprising: at least one processor; and at least one memory including computer program code, the at least one memory and computer program code configured to, with the at least one processor, cause the user equipment to perform: adopting, for an uplink transmission from the user equipment, a modified pattern of one or more time positions for reference signal symbols, such that the reference signal symbols for the uplink transmission do not occur in a region of overlap between a time unit for the uplink transmission and a time unit for another uplink transmission from the user equipment.

The reference signal symbols may facilitate demodulation of symbols of the uplink transmission.

The modified pattern of time positions may be different to another pattern of time positions used for the another uplink transmission.

The uplink transmission may be after the another uplink transmission.

The uplink transmission may comprise repetitions of data in respective groups of one or more uplink transmission slots; and the at least one memory and computer program code may be configured to, with the at least one processor, cause the user equipment to adopt the modified pattern of time positions selectively for the group of uplink transmission slots at the start of the uplink transmission.

The modified pattern of time positions may be different to the another pattern of time positions at least in relation to the time position of the earliest reference signal symbol for the uplink transmission.

The modified pattern of time positions may be different to the another pattern of time positions at least in relation to the earliest symbol of the uplink transmission.

The uplink transmission may be before the another uplink transmission.

The uplink transmission may comprise repetitions of data in respective groups of one or more uplink transmission slots, and the at least one memory and computer program code may be configured to, with the at least one processor, cause the user equipment to adopt the modified pattern of time positions for a plurality of the groups of uplink transmission slots.

The uplink transmission may comprise repetitions of data in respective groups of one or more uplink transmission slots, and the at least one memory and computer program code may be configured to, with the at least one processor, cause the user equipment to adopt the modified pattern of time positions selectively for the group of uplink transmission slots at the end of the uplink transmission.

The modified pattern of time positions may be different to the another pattern of time positions at least in relation to the time position of the last reference signal symbol for the uplink transmission.

The modified pattern of time positions may be different to the another pattern of time positions at least in relation to the last symbol of the uplink transmission.

The modified pattern of time positions may take into account a change in timing advance between the uplink transmission and the another uplink transmission.

Adopting the modified pattern of time positions may be dependent on the change in timing advance exceeding a threshold value.

The modified pattern may be a pre-defined pattern.

The modified pattern may be a pattern configured in downlink control information, medium access control or radio resource control signaling.

The modified pattern of time positions may be based at least partly on a size of the change in timing advance.

The modified pattern of time positions may be based at least party on symbol length.

Apparatus comprising: at least one processor; and at least one memory including computer program code, the at least one memory and computer program code configured to, with the at least one processor, cause the apparatus to perform: demodulating an uplink transmission from a user equipment, wherein the demodulating is performed on the basis that the uplink transmission adopts for reference signal symbols a pattern of time positions such that the reference signal symbols for the uplink transmission do not occur in a region of overlap between a time unit for the uplink transmission and a time unit for another uplink transmission from the user equipment.

Apparatus comprising: at least one processor; and at least one memory including computer program code, the at least one memory and computer program code configured to, with the at least one processor, cause the apparatus to perform: transmitting information about modifying an uplink pattern of time positions for reference signal symbols, such that the reference signal symbols for an uplink transmission from a user equipment do not occur in a region of overlap between a time unit for the uplink transmission and a time unit for another uplink transmission from the user equipment.

User equipment comprising: adopting circuitry for adopting, for an uplink transmission from the user equipment, a modified pattern of one or more time positions for reference signal symbols, such that the reference signal symbols for the uplink transmission do not occur in a region of overlap between a time unit for the uplink transmission and a time unit for another uplink transmission from the user equipment.

Apparatus, comprising: demodulating circuitry for demodulating an uplink transmission from a user equipment, wherein the demodulating is performed on the basis that the uplink transmission adopts for reference signal symbols a pattern of time positions such that the reference signal symbols for the uplink transmission do not occur in a region of overlap between a time unit for the uplink transmission and a time unit for another uplink transmission from the user equipment.

Apparatus, comprising: transmitting circuitry for transmitting information about modifying an uplink pattern of time positions for reference signal symbols, such that the reference signal symbols for an uplink transmission from a user equipment do not occur in a region of overlap between a time unit for the uplink transmission and a time unit for another uplink transmission from the user equipment.

A computer readable medium comprising program instructions stored thereon for performing: adopting, for an uplink transmission from a user equipment, a modified pattern of one or more time positions for reference signal symbols, such that the reference signal symbols for the uplink transmission do not occur in a region of overlap between a time unit for the uplink transmission and a time unit for another uplink transmission from the user equipment.

A computer readable medium comprising program instructions stored thereon for performing: demodulating an uplink transmission from a user equipment, wherein the demodulating is performed on the basis that the uplink transmission adopts for reference signal symbols a pattern of time positions such that the reference signal symbols for the uplink transmission do not occur in a region of overlap between a time unit for the uplink transmission and a time unit for another uplink transmission from the user equipment.

A computer readable medium comprising program instructions stored thereon for performing: transmitting information about modifying an uplink pattern of time positions for reference signal symbols, such that the reference signal symbols for an uplink transmission from the user equipment do not occur in a region of overlap between a time unit for the uplink transmission and a time unit for another uplink transmission from the user equipment.

A non-transitory computer readable medium comprising program instructions stored thereon for performing: adopting, for an uplink transmission from a user equipment, a modified pattern of one or more time positions for reference signal symbols, such that the reference signal symbols for the uplink transmission do not occur in a region of overlap between a time unit for the uplink transmission and a time unit for another uplink transmission from the user equipment.

A non-transitory computer readable medium comprising program instructions stored thereon for performing: demodulating an uplink transmission from a user equipment, wherein the demodulating is performed on the basis that the uplink transmission adopts for reference signal symbols a pattern of time positions such that the reference signal symbols for the uplink transmission do not occur in a region of overlap between a time unit for the uplink transmission and a time unit for another uplink transmission from the user equipment.

A non-transitory computer readable medium comprising program instructions stored thereon for performing: transmitting information about modifying an uplink pattern of time positions for reference signal symbols, such that the reference signal symbols for an uplink transmission from the user equipment do not occur in a region of overlap between a time unit for the uplink transmission and a time unit for another uplink transmission from the user equipment.

A computer program comprising computer executable code which when run on at least one processor is configured to cause a user equipment at least to: adopt, for an uplink transmission from the user equipment, a modified pattern of one or more time positions for reference signal symbols, such that the reference signal symbols for the uplink transmission do not occur in a region of overlap between a time unit for the uplink transmission and a time unit for another uplink transmission from the user equipment.

A computer program comprising computer executable code which when run on at least one processor is configured to cause an apparatus at least to: demodulate an uplink transmission from a user equipment, wherein the demodulating is performed on the basis that the uplink transmission adopts for reference signal symbols a pattern of time positions such that the reference signal symbols for the uplink transmission do not occur in a region of overlap between a time unit for the uplink transmission and a time unit for another uplink transmission from the user equipment.

A computer program comprising computer executable code which when run on at least one processor is configured to cause apparatus at least to: transmit information about modifying an uplink pattern of time positions for reference signal symbols, such that the reference signal symbols for an uplink transmission from a user equipment do not occur in a region of overlap between a time unit for the uplink transmission and a time unit for another uplink transmission from the user equipment.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows a representation of an example of an architecture to which embodiments may be applied;

FIG. 2 shows a representation of an example of a transmission slot structure;

FIG. 3 shows a representation of an example of an increase in timing advance (TA) for uplink transmissions by a user equipment;

FIG. 4 shows a representation of an example of operations of a user equipment in the architecture of FIG. 1, according to an example embodiment;

FIG. 5 shows a representation of an example of operations of a gNB in the architecture of FIG. 1, according to an example embodiment;

FIG. 6 shows a representation of an example of modifying an intra-slot pattern of timing positions for reference signal symbols according to an example embodiment;

FIG. 7 shows a representation of an example of modifying a pattern of timing positions for reference signal symbols for an uplink transmission comprising repetitions, according to an example embodiment;

FIG. 8 shows a representation of another example of modifying a pattern of timing positions for reference signal symbols for an uplink transmission comprising repetitions, according to another example embodiment;

FIG. 9 shows a representation of an example of apparatus for implementing the user equipment functionality of the user equipment of the architecture of FIG. 1 according to some example embodiments;

FIG. 10 shows a representation of an example of apparatus for implementing the gNB of the architecture of FIG. 1 according to some example embodiments and

FIG. 11 shows a representation of an example of non-volatile memory media.

### DETAILED DESCRIPTION

By way of example, the following description focusses on the example of transmissions between a user equipment (UE) and an access network AN operating according to 3GPP 5G technology, but the underlying technique may also be applicable to transmissions between user equipment and access network operating according to other technologies, such as more evolved 3GPP technologies.

The term “user equipment” (UE) may refer to any device, apparatus or component implementing at least 3GPP user equipment (UE) functionality.

The UE may be a mobile or static device (e.g. a portable or non-portable computing device) including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a UE device may also be a nearly exclusive uplink only device, of which an example is a camera or video camera loading images or video clips to a network. A UE device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a UE device may comprise a user portable device with radio parts (such as a watch, earphones or eyeglasses) and the computation is carried out in the cloud.

5G enables using multiple input—multiple output (MIMO) antennas, and may involve large numbers of base stations (gNBs) including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G may employ multiple radio interfaces, e.g. below 6G Hz or above 24 GHZ, cmWave and mmWave, and may also be integrable with existing legacy radio access technologies, such as LTE. Integration with LTE may be implemented, as a system, where macro coverage is provided by LTE and 5G radio interface access comes from small cells by aggregation to the LTE. In other words, 5G may support both inter-RAT operability (such as LTE-5G) and inter-RI operability (inter-radio interface operability, such as below 6 GHz-cmWave, 6 or above 24 GHz-cmWave and mmWave). 5G networks may employ network slicing, in which multiple independent and dedicated virtual sub-networks (network instances) may be created within the same infrastructure to run services that have different requirements on latency, reliability, throughput and mobility.

Low latency applications and services may be facilitated by bringing content close to the 5G system, which leads to local break out and multi-access edge computing (MEC). 5G enables analytics and knowledge generation to occur at the source of the data. This approach may involve leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

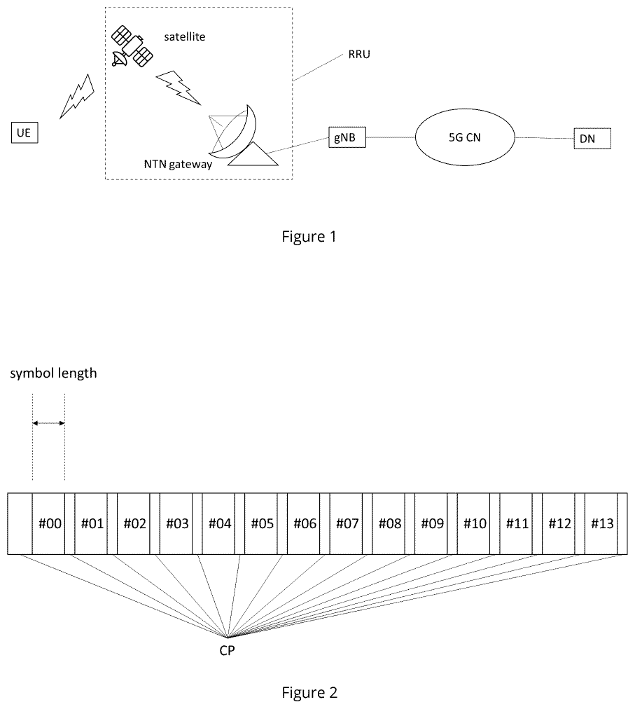

FIG. 1 shows an example of a 5G NR NTN architecture for a connection between a UE and a data network (DN) via a satellite, a NTN (Non-Terrestial Network) gateway, gNB, and 5G core network (5G CN).

This example architecture is a transparent satellite based architecture of the kind described in 3GPP TR 38.821, in which the satellite payload implements frequency conversion and a radio frequency amplifier in both the uplink and downlink directions. The satellite and NTN gateway together function as a remote radio unit (RRU) for the gNB.

There can be a significant variation in the propagation delay between the UE and the satellite (and also the satellite and the NTN gateway), resulting from the orbital movement of the satellite. As mentioned in more detail below, significant variations in the propagation delay can result in significant changes in the timing advance (TA) for uplink transmissions to the gNB via the satellite and NTN gateway.

Uplink transmissions for the 5G NR Physical Uplink Shared Channel (PUSCH) and 5G NR Physical Uplink Control Channel (PUCCH) use a timing structure based on transmission slots, e.g. time unit as slot or multiple symbols for mini-slot. With reference to FIG. 2, a transmission slot for 5G NR PUSCH/PUCCH comprises a plurality of OFDM (orthogonal frequency division multiplexing) symbols at respective time positions within the slot.

The number of OFDM symbols in the slot or mini-slot depends on the duration (time length) of the OFDM symbols, which depends on the sub-carrier spacing (SCS). Cyclic prefix are provided between each pair of adjacent symbols, including between the first symbol of the slot and the last symbol of the previous slot, and between the last symbol of the slot and the first symbol of the next slot. These cyclic prefixes avoid inter symbol interference (ISI). The length (Tg) of the cyclic prefix may be greater than the maximum delay over the radio channel.

Some of the OFDM symbols within the slot carry user data, and one or more of the OFDM symbols within the slot carry demodulation reference signals (DMRS) to assist demodulation at the gNB of the OFDM symbols carrying user data. The intra-slot pattern of positions for the one or more DMRS symbols may include a DMRS symbol in at the front part of the slot or mini-slot, e.g at the. first, OFDM symbol in the slot or mini-slot.

UE may control the timing of the uplink transmission slots based on the timing at which the UE receives downlink transmission slots, and a timing advance (TA) command. In NTN, the TA may also be based on UE adjusted TA and/or common TA for propagation delay between UE and gNB. The TA is a negative offset between the timing at which the UE receives the start of a downlink slot, and the timing at which UE starts the transmission of an uplink slot.

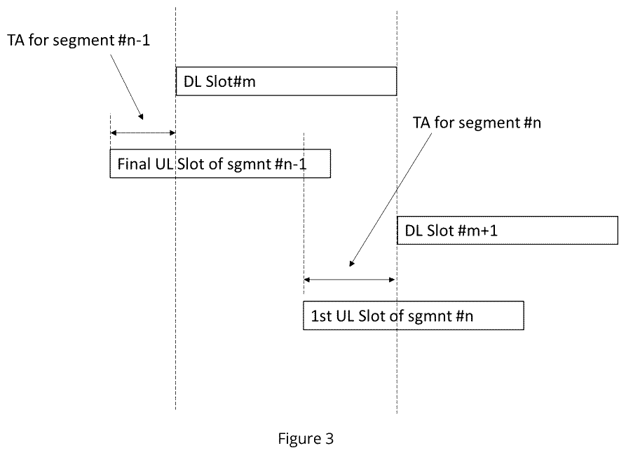

As one example, the UE adopts the same TA for a segment. A segment is an uplink transmission comprising one or more time units (e.g. 5G slots). As shown in FIG. 3, an increase in the TA for a segment #n compared to the TA for the previous segment #n−1 results in an overlap between the final transmission slot of segment #n−1 and the first slot of segment #n.

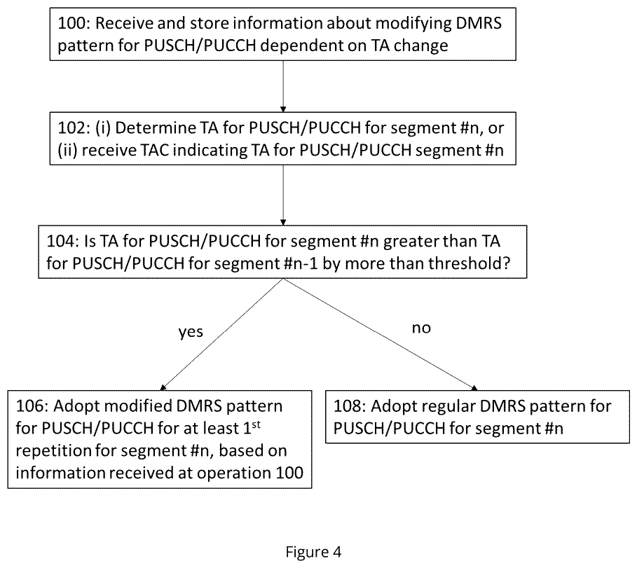

FIGS. 4 and 5 show representations of examples of operations at UE and gNB of FIG. 1 according to an example embodiment.

### Operations 100 and 200

UE acquires information via one or more downlink transmissions about making modifications to the intra-slot pattern of positions for DRMS symbols dependent on overlap between UL transmission time units e.g. a change in TA between segments. This information may be a part of downlink control information (DCI) included in a physical downlink control channel (PDCCH) transmission. Alternatively, this information may be part of a radio resource control (RRC) message or MAC message included in a physical downlink shared channel transmission (PDSCH) scheduled by a PDCCH transmission.

Alternatively, there may be a pre-defined rule about modifying the intra-slot pattern of positions for DRMS symbols dependent on overlap between UL transmission time units, e.g. a change in TA between segments; and UE may have this pre-defined rule stored in memory even before being served by gNB.

### Operations 102 and 202

In preparation for a new segment #n: either (i) UE determines (e.g. based on GNSS (Global Navigation Satellite System) signals) a TA for PUSCH/PUCCH transmissions for segment #n and reports the TA to gNB, or (ii) gNB determines a TA for PUSCH/PUCCH transmissions for segment #n, and sends to UE a TA command (TAC) indicating the TA for segment #n.

### Operations 104 and 204

Both UE and gNB determine whether the TA for segment #n is greater than the TA for the previous segment #n−1 by more than a threshold amount. The threshold amount may have been indicated to UE in one or more earlier downlink transmissions by gNB. The threshold amount may depend on the size of the guard period (including CP) at the start of transmission slots, which, as mentioned above, may depend on the sub-carrier spacing used for the PUSCH/PUCCH transmissions.

### Operations 108 and 208

If the TA change is determined not to exceed the threshold, the UE makes no change to the regular intra-slot pattern of DMRS symbols for the slots of segment #n. In this example, the regular intra-slot pattern of DMRS symbols for PUSCH/PUCCH transmissions includes a DMRS symbol at a dedicated position in the front part of the slot, e.g. the first symbol of the slot. The provision of a DMRS symbol early in the slot facilitates early channel estimation for correct decoding of the data symbols. gNB demodulates the PUSCH/PUCCH transmissions of UE in segment #n on the basis that UE adopts a regular DMRS pattern for segment #n.

### Operations 106 and 208

On the other hand, if the TA change does exceed the threshold amount, UE adopts a modified DMRS pattern for at least the first slot of segment #n, in accordance with the information provided by gNB about modifying the DMRS pattern, which can be dependent on TA change (or in accordance with the pre-defined rules modifying the DMRS pattern dependent on TA change). The modified DMRS pattern may depend on the extent by which the TA change exceeds the threshold, in accordance with the information provided by gNB about modifying the DMRS pattern dependent on TA change (or in accordance with the pre-defined rules modifying the DMRS pattern dependent on TA change).

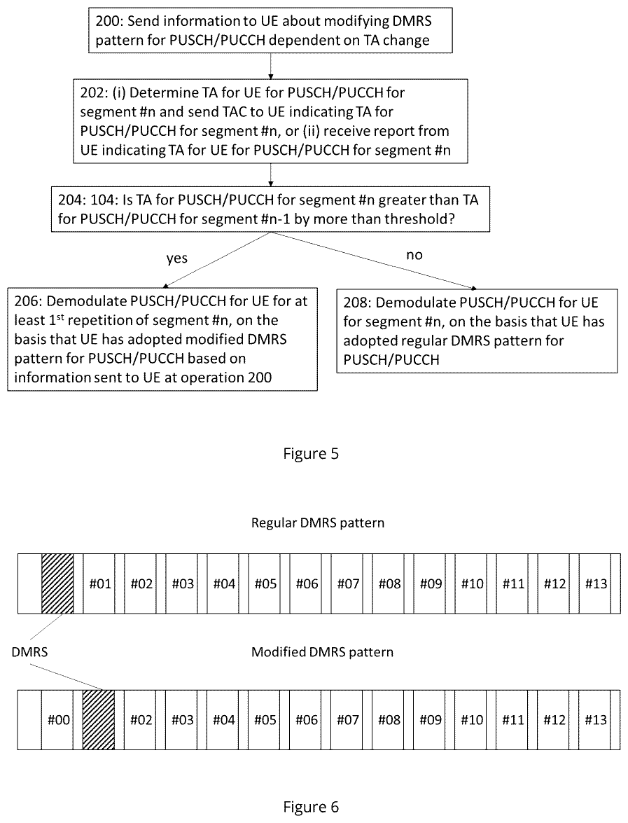

FIG. 6 shows an example of a modified DMRS pattern comprising a DMRS symbol at the 2^{nd} symbol (#01) of the slot instead of at the 1^{st} symbol (#00) for a regular DMRS pattern. The slot may include additional DMRS symbols at other positions within the slot. The time position for the additional DMRS symbols may be the same for both the regular DMRS pattern and the modified DMRS pattern; and the total number of DMRS symbols within the slot may be the same for both the regular and modified DMRS patterns.

For larger changes in TA and/or for slot structures comprising a greater number of symbols of shorter symbol duration (length), the modified DMRS pattern may have the 1^{st} DMRS symbol at the third OFDM symbol (#2) of the slot or even later OFDM symbols within the slot. More generally, the modified DMRS pattern does not include any DMRS symbols in time positions partly or wholly within the range of overlap between the final slot of segment #n−1 and the first slot of segment #n.

gNB demodulates PUSCH/PUCCH transmissions from UE in segment #n on the basis that UE follows the information provided by gNB about modifying the DMRS pattern dependent on TA change, or UE follows the pre-defined rules about modifying the DMRS pattern dependent on TA change. gNB demodulates PUSCH/PUCCH transmissions from UE in segment #n, on the basis that UE uses a modified DMRS pattern in accordance with the information provided by gNB about modifying the DMRS pattern dependent on TA change, or in accordance with the pre-defined rules about modifying the DMRS pattern dependent on TA change.

### Repetitions

A segment (PUSCH/PUCCH transmission comprising one or more slots) may comprise repetitions of a data set. Each repetition may use one or more slots, wherein the number of slots depends on the number of resource units (RUs) that the data set occupies, and the number of slots per RU.

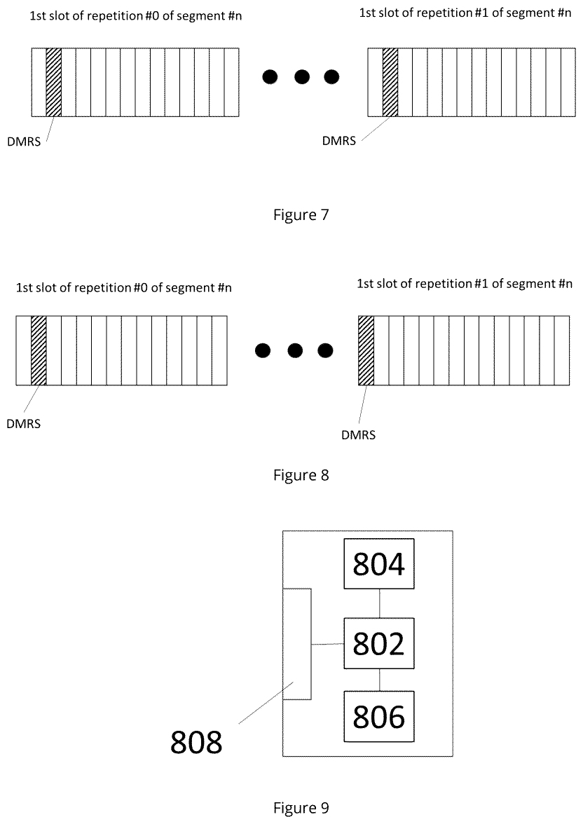

FIG. 7 shows a representation of one example according to which UE adopts a modified DMRS pattern for segment #n, and uses the modified DMRS pattern for all repetitions within segment #n. FIG. 8 shows a representation of another example, according to which UE adopts a modified DMRS pattern for segment #n, but uses the modified DMRS pattern solely for the first repetition of segment #n (including the first slot of segment #n), and reverts to the regular DMRS pattern for all subsequent repetitions within segment #n.

The above examples involve modifying the DMRS pattern for at least the first slot for segment #n in response to determining that the TA change between segment #n−1 and segment #n exceeds a threshold. One variation involves instead modifying the DMRS pattern in the final slot of segment #n−1. This modification may involve moving a DMRS symbol from the final OFDM symbol of the final slot of segment #n−1 to an earlier position within the final slot of segment #n−1.

In all of the above examples, the DMRS symbol is moved to a time position outside any position of overlap between the final slot of segment #n−1 and the first slot of segment #n. The OFDM symbols or parts of OFDM symbols within the overlap between slots of segments #n−1 and #n are dropped from one of the two overlapping slots, either from the first slot of segment #n or the final slot of segment #n−1.

According to one example, the sequence (e.g. Zadoff-Chu type sequence) used for the DMRS symbol(s) whose position is modified does not change between the regular DMRS pattern and the modified DMRS pattern. The same sequence is used irrespective of whether the DMRS symbol is in the regular time position, or is moved to a different time position within the slot.

The above example techniques facilitate good channel estimation and coherent demodulation by the gNB even in the event of a jump in TA between segments. The above example techniques can be particularly beneficial for slot structures comprising only one DMRS symbol at the front of the slot.

FIG. 9 illustrates an example of an apparatus for implementing UE functionality in the architecture of FIG. 1. The apparatus may include at least one processor 802 coupled to one or more interfaces 808. The one or more interfaces 808 may include one or more interfaces to e.g. other equipment/component(s) for which the UE functionality provides radio communications. The at least one processor 802 is also coupled to a radio unit 804 including one or more antennas etc. for making and receiving radio transmissions. The at least one processor 802 may also be coupled to at least one memory 806. The at least one processor 802 may be configured to execute an appropriate software code to perform the operations described above. The software code may be stored in the memory 806.

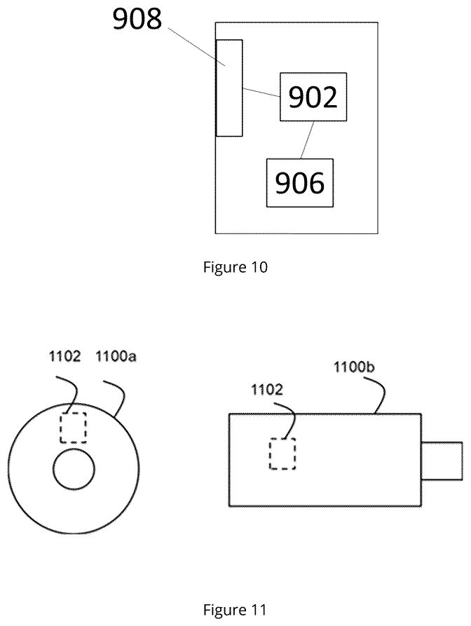

FIG. 10 illustrates an example of an apparatus for implementing the gNB in the architecture of FIG. 1. The apparatus may include at least one processor 902 coupled to one or more interfaces 908 for communication with at least the core network and the NTN gateway. The at least one processor 902 may also be coupled to at least one memory 906. The at least one processor 902 may be configured to execute an appropriate software code to perform the operations described above. The software code may be stored in the memory 906.

FIG. 11 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described example embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The features, advantages, and characteristics described herein can be combined in any suitable manner in one or more example embodiments. One skilled in the relevant art will recognize that such example embodiments can be practiced without one or more of the specific features or advantages of a particular embodiment. In other instances, additional features and advantages can be recognized in certain embodiments that may not be present in all example embodiments. One having ordinary skill in the art will readily understand that the example embodiments as discussed above may be practiced with steps in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-72. (canceled)

73. A method, comprising:
adopting, for an uplink transmission from a user equipment, a modified pattern of time positions for reference signal symbols, such that the reference signal symbols for the uplink transmission do not occur in a region of overlap between a time unit for the uplink transmission and a time unit for another uplink transmission from the user equipment that is before the uplink transmission, wherein the reference signal symbols facilitate demodulation of symbols of the uplink transmission, wherein the uplink transmission comprises repetitions of data in respective groups of one or more uplink transmission slots; and
adopting the modified pattern of time positions selectively for a group from the respective groups of the one or more uplink transmission slots at a start of the uplink transmission, wherein adopting the modified pattern of time positions is dependent on a change in timing advance exceeding a threshold value, wherein the modified pattern of time positions is different to the another pattern of time positions at least in relation to the time position of an earliest reference signal symbol for the uplink transmission, wherein the modified pattern of time positions takes into account a change in timing advance between the uplink transmission and the another uplink transmission.

74. The method of claim 73, wherein the modified pattern is a pre-defined pattern.

75. The method of claim 74, wherein the modified pattern is a pattern configured in downlink control information.

76. The method of claim 74, wherein the modified pattern is a pattern configured in, medium access control.

77. The method of claim 76, wherein the modified pattern is a pattern configured in radio resource control signaling.

78. The method of claim 77, wherein the modified pattern of time positions is based on symbol length.

79. The method of claim 78, further comprising receiving, from a server, information about modifying the uplink pattern of time positions for the reference signal symbols.

80. An apparats comprising:
at least one processor; and
at least one memory including computer program code;
the at least one memory and the computer program code are configured to, with the at least one processor, cause the apparats to perform the following operations:
adopting, for an uplink transmission from a user equipment, a modified pattern of time positions for reference signal symbols, such that the reference signal symbols for the uplink transmission do not occur in a region of overlap between a time unit for the uplink transmission and a time unit for another uplink transmission from the user equipment that is before the uplink transmission, wherein the reference signal symbols facilitate demodulation of symbols of the uplink transmission, wherein the uplink transmission comprises repetitions of data in respective groups of one or more uplink transmission slots; and
adopting the modified pattern of time positions selectively for a group from the respective groups of the one or more uplink transmission slots at a start of the uplink transmission, wherein adopting the modified pattern of time positions is dependent on a change in timing advance exceeding a threshold value, wherein the modified pattern of time positions is different to the another pattern of time positions at least in relation to the time position of an earliest reference signal symbol for the uplink transmission, wherein the modified pattern of time positions takes into account a change in timing advance between the uplink transmission and the another uplink transmission.

81. The apparats of claim 80, wherein the modified pattern is a pre-defined pattern.

82. The apparats of claim 81, wherein the modified pattern is a pattern configured in downlink control information.

83. The apparats of claim 81, wherein the modified pattern is a pattern configured in, medium access control.

84. The apparats of claim 81, wherein the modified pattern is a pattern configured in radio resource control signaling.

85. The apparats of claim 84, wherein the modified pattern of time positions is based on symbol length.

86. The apparats of claim 85, wherein the at least one memory and the computer program code are configured to, with the at least one processor, to further cause the apparats to perform the following operations:
receiving, from a server, information about modifying the uplink pattern of time positions for the reference signal symbols.

87. A system comprising:
an apparats comprising:
at least one processor; and
at least one memory including computer program code;
the at least one memory and the computer program code are configured to, with the at least one processor, cause the apparats to perform the following operations:
adopting, for an uplink transmission from a user equipment, a modified pattern of time positions for reference signal symbols, such that the reference signal symbols for the uplink transmission do not occur in a region of overlap between a time unit for the uplink transmission and a time unit for another uplink transmission from the user equipment that is before the uplink transmission, wherein the reference signal symbols facilitate demodulation of symbols of the uplink transmission, wherein the uplink transmission comprises repetitions of data in respective groups of one or more uplink transmission slots; and
adopting the modified pattern of time positions selectively for a group from the respective groups of the one or more uplink transmission slots at a start of the uplink transmission, wherein adopting the modified pattern of time positions is dependent on a change in timing advance exceeding a threshold value, wherein the modified pattern of time positions is different to the another pattern of time positions at least in relation to the time position of an earliest reference signal symbol for the uplink transmission, wherein the modified pattern of time positions takes into account a change in timing advance between the uplink transmission and the another uplink transmission.

88. The system of claim 87, wherein the modified pattern is a pre-defined pattern.

89. The system of claim 87, wherein the modified pattern is a pattern configured in downlink control information.

90. The system of claim 87, wherein the modified pattern is a pattern configured in, medium access control.

91. The system of claim 87, wherein the modified pattern is a pattern configured in radio resource control signaling.

92. The system of claim 91, wherein the modified pattern of time positions is based on symbol length, and wherein the at least one memory and the computer program code are configured to, with the at least one processor, to further cause the apparats to perform the following operations:
receiving, from a server, information about modifying the uplink pattern of time positions for the reference signal symbols.
